(19) United States
(12) Patent Application Publication
(10) Pub. No.: US 2026/0338150 A1
(43) Pub. Date: Oct. 29, 2026

(54) SYSTEMS AND METHODS FOR PARTICLE EMISSIONS MANAGEMENT

(71) Applicant: Cummins Inc., Columbus, IN (US)

(72) Inventors: Prasad Deepak Gandhi, Pune (IN); Priyavrat Purushottam Sathe, Pune (IN); Ajay Chandulal Mehta, Pune (IN)

(73) Assignee: Cummins Inc., Columbus, IN (US)

(21) Appl. No.: 19/653,854

(22) Filed: Apr. 21, 2026

(30) Foreign Application Priority Data
Apr. 25, 2025 (IN) 202541040090

(51) Int. Cl. F02P 5/15

(52) U.S. Cl. CPC F02P 5/1502

(57) ABSTRACT

A system includes an igniter configured to ignite an air-fuel mixture according to a base spark timing, and a controller coupled with the igniter. The controller is configured to perform operations, including receiving, from one or more sensors, (a) data indicative of an engine load and (b) data indicative of a pressure within an intake manifold coupled with an engine including the engine cylinder. The operations include determining whether the engine load is a low load condition or an idle condition and detecting a presence of a vacuum within the intake manifold. The operations include operating the igniter to delay ignition of the air-fuel mixture within the combustion chamber relative to the base spark timing based on (a) determining that the engine load is the low load condition or the idle condition and (b) detecting the presence of the vacuum within the intake manifold.

### CROSS-REFERENCE TO RELATED APPLICATION

This Application claims the benefit of and priority to Indian Provisional Application No. 202541040090, filed Apr. 25, 2025, which is hereby incorporated by reference herein in its entirety.

### TECHNICAL FIELD

The present disclosure relates generally to the field of engine system controls. Specifically, the present disclosure relates to engine system controls for spark timing to manage or control particle emissions from the engine system.

### BACKGROUND

The efficiency, performance, and emissions of internal combustion engines are largely influenced by the timing of the spark that ignites the air-fuel mixture within a combustion chamber of the engine. Spark timing refers to the precise moment at which the spark-initiating device (e.g., spark plug, glow plug, etc.) is triggered to initiate combustion. Traditional spark timing control systems often rely on a fixed or predetermined ignition map, which adjusts the timing based on the engine's operating conditions, such as speed and load.

Internal combustion engines are often subject to various operating desires, such as maintaining emissions of certain exhaust gas constituents at or below one or more predefined thresholds. Exhaust aftertreatment systems may be implemented to reduce emissions of certain unwanted exhaust gas constituents (e.g., particulate matter).

### SUMMARY

One embodiment relates to a system for controlling spark timing. The system includes an igniter. The igniter is configured to ignite an air-fuel mixture within a combustion chamber of an engine cylinder according to a base spark timing. The system includes a controller coupled with the igniter. The controller includes one or more processing circuits having one or more memory devices coupled to one or more processors, the one or more memory devices configured to store instructions thereon that, when executed by the one or more processors, cause the one or more processors to perform operations. The operations include receiving, from one or more sensors, data indicative of an engine load. The operations include receiving, from the one or more sensors, data indicative of a pressure within an intake manifold coupled with an engine including the engine cylinder. The operations include determining whether the engine load is a low load condition or an idle condition and detecting a presence of a vacuum within the intake manifold based on the data indicative of the pressure within the intake manifold. The operations include operating the igniter to delay ignition of the air-fuel mixture within the combustion chamber relative to the base spark timing based on (a) determining that the engine load is the low load condition or the idle condition and (b) detecting the presence of the vacuum within the intake manifold.

Another embodiment relates to control system for controlling spark timing. The control system includes one or more processing circuits having one or more memory devices coupled to one or more processors, the one or more memory devices configured to store instructions thereon that, when executed by the one or more processors, cause the one or more processors to perform operations. The operations include receiving an indication of an engine load of an engine is a low load condition or an idle condition. The operations include detecting a presence of a vacuum within an intake manifold coupled with an engine based on data indicative of pressure within the intake manifold. The operations include operating an igniter to delay ignition of an air-fuel mixture within a combustion chamber of the engine relative to a base spark timing based on (a) the engine load being the low load condition or the idle condition and (b) detecting the presence of the vacuum within the intake manifold.

Yet another embodiment relates to a method of controlling spark timing. The method includes receiving, from one or more sensors, data indicative of an engine load of an engine. The method includes receiving, from the one or more sensors, data indicative of a pressure within an intake manifold coupled with the engine. The method includes determining whether the engine load is a low load condition or an idle condition. The method includes detecting a presence of a vacuum within the intake manifold based on the data indicative of the pressure within the intake manifold. The method includes operating an igniter to delay ignition of an air-fuel mixture within a combustion chamber of the engine relative to a base spark timing based on (a) determining that the engine load is the low load condition or the idle condition and (b) detecting the presence of the vacuum within the intake manifold.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a schematic diagram of an engine system, according to an example embodiment.

FIG. 2 is a schematic diagram of a portion of the engine system of FIG. 1, according to an example embodiment.

FIG. 3 is a schematic diagram of a cylinder within the engine system of FIG. 1, according to an example embodiment.

FIG. 4 is a block diagram of a controller of the system of FIG. 1, according to an example embodiment.

FIG. 5 is a graphical diagram of predefined acceptable operating values associated with the engine system of FIG. 1, according to an example embodiment.

FIG. 6 is a flow diagram of a process for adjusting spark timing of the engine system of FIG. 1, according to an example embodiment.

### DETAILED DESCRIPTION

Following below are more detailed descriptions of various concepts related to, and implementations of methods, apparatuses, and systems for adjusting spark timing within an engine system, while an engine is operating under certain conditions, such as a low load or idle condition (described in further detail below). The systems, computer-readable media, and methods described herein may be applicable to a variety of different engine system configurations and engine types. Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

Engines and, specifically, internal combustion engines (ICEs) generate emissions, such as particulate matter, during combustion of air and fuel within a combustion chamber of the engine. One emissions characteristic is the particle number. The particle number (PN) is a measure of the number of particulate matter (PM) emissions emitted by an engine. More particularly, the PN refers to a total number of solid particles emitted (e.g., from the system exhaust), quantified according to the dilution, sampling, and measurement methods as specified one or more regulations by one or more regulatory authorities. The PN is often described in particles-per-unit of distance or power (e.g., kilowatt-hour). In contrast, PM emissions typically measure the quantity, and not the particular number like PN emissions. Regulatory authorities may prescribe various thresholds to limit PN emissions, such that PN emissions must fall below a predefined threshold in order to comply with certain regulations. A PN analyzer may be installed on tailpipe of system, such as a vehicle, to count the PN during an emission cycle. An emission cycle is a predefined sequence of conditions used to measure and evaluate exhaust emissions from an engine.

Based on the foregoing and referring to the Figures generally, the various embodiments disclosed herein relate to systems, apparatuses, and methods for controlling spark timing within an engine system to limit PN emissions. A system for controlling spark timing may include an igniter configured to ignite an air-fuel mixture within a combustion chamber of an engine cylinder according to a base spark timing. The system may include one or more sensors coupled with components of an engine system, such as an intake manifold, an exhaust manifold, an aftertreatment, etc. For example, the components include an intake manifold configured to direct gas to the combustion chamber of the engine cylinder. The system includes a controller coupled with the igniter and the one or more sensors. The controller includes one or more processing circuits comprising one or more memory devices coupled to one or more processors, the one or more memory devices configured to store instructions thereon. Upon executing the instructions, the controller receives, from the one or more sensors, data indicative of an engine load. As will be described more fully herein, “engine load” refers to and includes idle conditions, low load conditions, moderate load conditions, or high load conditions, among other load conditions. The controller receives, from the one or more sensors, data indicative of a pressure within an intake manifold. The controller determines whether the engine load is a low load condition or an idle condition based on the sensor data. The controller may further detect a presence of a vacuum within the intake manifold based on the data indicative of the pressure within the intake manifold. The controller operates the igniter to delay ignition of the air-fuel mixture within the combustion chamber relative to the base spark timing based on (a) determining that the engine load is the low load condition or the idle condition and (b) detecting the presence of the vacuum within the intake manifold.

As will be described more fully herein, the vacuum within the intake manifold pulls in oil that is present in various parts of the engine into the combustion chambers of the engine cylinders. This oil pulled into the combustion chambers burns alongside an air-fuel mixture when the igniter ignites the contents of the combustion chamber(s). Burning the oil along with the air-fuel mixture results in exhaust gas having a relatively higher particle number (PN) relative to exhaust gas produced by burning only the air-fuel mixture. Technically and beneficially, adjusting the spark timing may reduce the vacuum within the intake manifold (e.g., by increasing the pressure within the intake manifold relative to the vacuum pressure), thereby reducing or preventing oil from being sucked into the combustion chamber and ignited. Advantageously, this serves to manage PN emissions without the need to add additional devices or components to the engine system, such as particle filter. Technically and beneficially, the architecture for controlling spark timing to reduce a vacuum within an intake manifold may be applicable to a number of engine systems having multiple types of air-intake throttle bodies. These and other features and benefits are described more fully herein below.

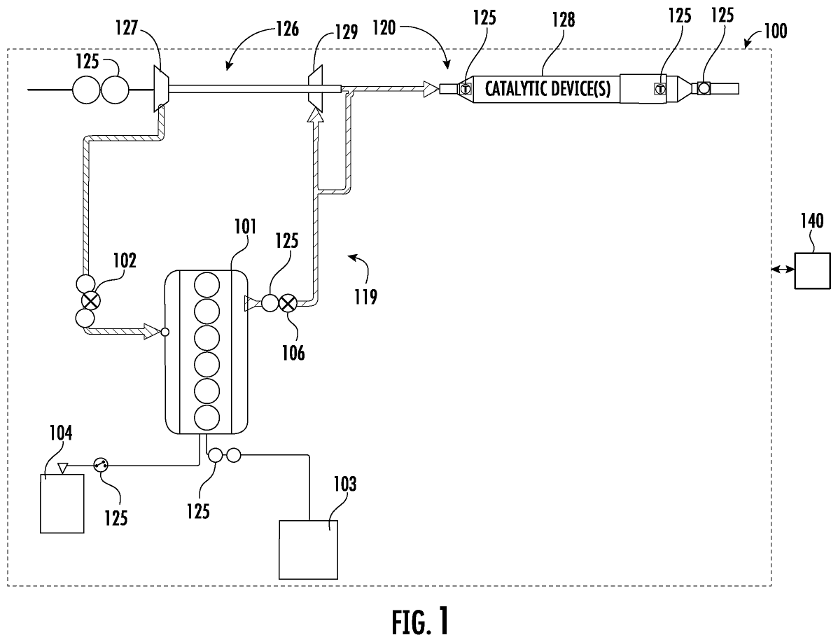

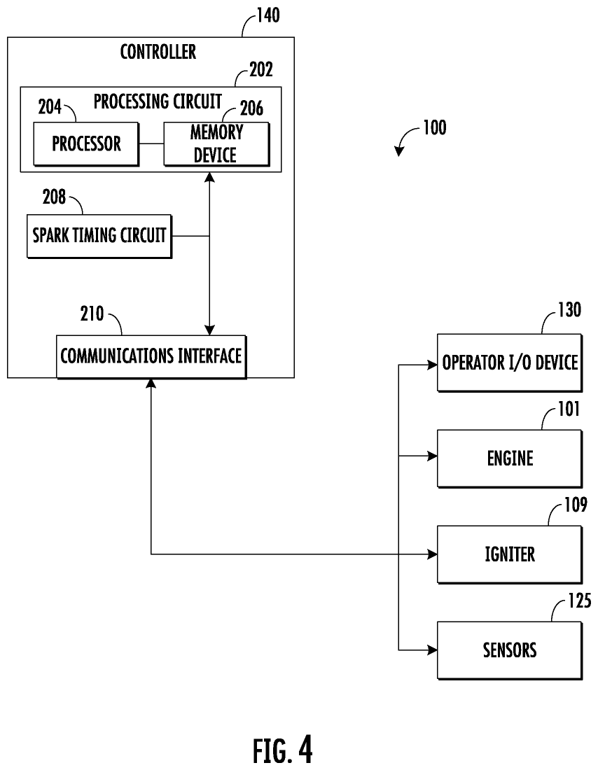

Now referring to FIG. 1, a schematic view of a block diagram of a system 100 is shown, according to an example embodiment. The system 100 includes an engine 101 and an aftertreatment system 120. The aftertreatment system 120 is in exhaust gas receiving communication with the engine 101. The system 100 may also include a controller 140 and an operator input/output (I/O) device (shown in FIG. 4), where the controller 140 is communicably coupled to each of the aforementioned components. In the configuration of FIG. 1, the system 100 is included in a vehicle. The vehicle may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. In another embodiment, the system 100 may be embodied in a stationary piece of equipment, such as a power generator or genset. All such variations are intended to fall within the scope of the present disclosure.

The engine 101 may be any type of internal combustion engine that generates exhaust gas, such as a gasoline-fueled, natural gas-fueled, diesel-fueled, and/or any other suitable engine. In the example depicted, the engine 101 is a part of a diesel-fueled engine system. In other embodiments, the engine 101 is part of a hybrid engine system having a combination of an internal combustion engine and at least one electric motor coupled to at least one battery. In some embodiments, the hybrid engine system may be configured as a mild-hybrid powertrain, a parallel hybrid powertrain, a series hybrid powertrain, or a series-parallel powertrain.

As shown in FIG. 1, an intake air throttle (IAT) valve 102, a fuel system 103, an oil system 104, and an aftertreatment system 120 are coupled to the engine 101. The IAT valve 102 is structured to control the amount of air supplied to the engine 101. The fuel system 103 is structured to provide fuel to the engine 101 (e.g., from a fuel source). The fuel system 103 may control one or more fueling parameters including a fuel amount, a fuel pressure, a fuel injection timing, etc. The oil system 104 is configured to provide a lubricant (e.g., lubricant oil) to the engine 101. For example, the oil system 104 may deliver oil to the engine 101.

The IAT valve 102 is a valve positioned at an air inlet of the engine 101. The IAT valve 102 may be actuated (e.g., by an actuator controlled by the controller 140) between a fully opened position, a closed position, and a plurality of positions between the fully opened open and fully closed positions (e.g., partially open positions). In the fully opened position, the IAT valve 102 allows a maximum amount of air to flow from the air intake to the engine 101. In some embodiments, the IAT valve 102 allows a minimum amount of air to flow from the air intake to the engine 101, while the IAT valve 102 is in the fully closed position. In other embodiments, the closed position of the IAT valve 102 is a position in which no air, or substantially no air, flows through the IAT valve 102 to the engine 101. The controller 140 may selectively actuate the IAT valve 102 (e.g., by controlling the actuator) in a plurality of positions between and/or including the open position and the closed position to adjust the amount of air received by the engine 101.

A turbo device 126 is shown to be disposed between the engine 101 and the aftertreatment system 120, such that the turbo device 126 is in exhaust gas receiving communication with the engine 101 and exhaust gas providing communication with the aftertreatment system 120, may be any type of turbo machinery, such as a turbocharger, a supercharger, a variable geometry turbocharger, a power turbine, etc. The turbo device 126 may be operatively coupled to the engine 101 and/or another component of the engine system 100, such as a drivetrain, a battery, an electric machine, or other suitable component. The turbo device 126 includes a turbine 129 and the compressor 127, connected by a shaft. The turbine 129 receives exhaust gas output by the engine 101 (e.g., via an exhaust conduit 119), whereas the compressor 127 draws in ambient air. The exhaust gases from the engine 101 spin a wheel within the turbine 129, which in turn drives a wheel within the compressor 127 on the other side of the turbo device 126. The compressor 127 draws in and compresses ambient air before forcing it into the engine 101. The compressor 127 of the turbo device 126 increases the density of the ambient air it intakes (e.g., relative to the ambient air pre-intake by the turbo device 126) by compressing the air, which may, in turn, force a greater volume of air into the engine 101 (e.g., relative to the less dense pre-intake ambient air).

The aftertreatment system 120 is in exhaust-gas receiving communication with the engine 101. In the example depicted, the aftertreatment system 120 includes one or more catalytic devices 128. For example, the aftertreatment system 120 may include a catalytic device 128 structured as a three way catalyst. A three way catalyst (TWC) is an emissions controls device structured to oxidize one or more gas constituents (e.g., nitrous oxide, hydrocarbon, carbon monoxide, etc.). The TWC facilitate the oxidation of carbon monoxide (CO) to carbon dioxide (CO₂), the oxidation of unburned hydrocarbons (HC) to carbon dioxide and water, and the reduction of nitrogen oxides (NOₓ) to nitrogen gas. The TWC typically includes a ceramic or metallic honeycomb substrate coated with metals such as platinum, palladium, and rhodium, which serve as sites for the oxidation reactions. The TWC may require the engine 101 to operate at or near a predefined air-fuel ratio (e.g., approximately 14.7:1 for gasoline engines), to effectively perform the oxidation and reduction processes.

In other embodiments, the aftertreatment system 120 may include a catalytic device 128 structured as a selective catalytic reduction (SCR) system (and/or other catalytic devices and/or exhaust gas purifying devices)). The SCR is configured to assist in the reduction of NOx emissions by accelerating a NOx reduction process between the ammonia and the NOx of the exhaust gas into diatomic nitrogen (N2) and water (H2O). If the SCR catalyst is not at or above a certain temperature, the acceleration of the NOx reduction process is limited and the SCR may not be operating at a level of a desired conversion efficiency (i.e., a value indicative of an amount of reduction of NOx emissions, also referred to as “deNOx efficiency”). In some embodiments, this certain temperature is approximately 200-600 °C. The SCR catalyst may be made from a combination of an inactive material and an active catalyst, such that the inactive material (e.g., ceramic substrate) directs the exhaust gas towards the active catalyst, which is any sort of material suitable for catalytic reduction (e.g., metal exchanged zeolite (Fe or Cu/zeolite), base metals oxides like vanadium, molybdenum, tungsten, etc.).

In some embodiments, the aftertreatment system 120 may include a filter, such as a particulate filter (PF). The PF may be arranged or positioned upstream of the SRC and is structured to remove particulates or particulate matter, such as soot, from exhaust gas flowing in the exhaust gas stream. The PF includes an inlet, where the exhaust gas is received, and an outlet, where the exhaust gas exits after having particulate matter substantially filtered from the exhaust gas. In some implementations, the PF or other components, even the aftertreatment system 120 itself, may be omitted and/or other components added (e.g., a second SCR system having an additional dosing unit or module, a diesel oxidation catalyst (DOC), an ammonia slip catalyst (ASC), etc.). The arrangement of components within the aftertreatment system 120 may be different in various embodiments (e.g., the PF may be positioned downstream of the SCR). The aftertreatment system may include any suitable type of catalytic device or catalytic devices. All such variations are intended to fall within the scope of the present disclosure.

As shown, a plurality of sensors 125 are included in the aftertreatment system 120. The number, placement, and type of sensors included in the aftertreatment system 120 is shown for example purposes only. That is, in other configurations, the number, placement, and type of sensors may differ. The sensors 125 may be gas constituent sensors (e.g., NOx sensors, oxygen sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. The gas constituent sensors may include an oxygen sensor that is structured to acquire data indicative of the presence of oxygen in the exhaust gas. The data from the oxygen sensor may be used to estimate an AFR value. The flow rate sensors may include a mass air flow (MAF) sensor structured to acquire data indicative of a mass flow rate of the exhaust gas. The temperature sensors are structured to acquire data indicative of a temperature value at each location where the temperature sensor is located.

The sensors 125 may be located in or proximate the engine 101, after the engine 101 and before the aftertreatment system 120, after the aftertreatment system 120, in the aftertreatment system 120, upstream of the engine 101, etc. It should be understood that the location of the sensors may vary. In one embodiment, there may be sensors 125 located both before and after the aftertreatment system 120. In one embodiment, at least one of the sensors is structured as exhaust gas constituent sensors (e.g., CO, NOx, PM, SOx, etc. sensors). In another embodiment, at least one of the sensors 125 is structured as non-exhaust gas constituent sensors that are used to estimate exhaust gas emissions (e.g., temperature, flowrate, pressure, etc.). Additional sensors may be also included with the system 100. The sensors may include engine-related sensors (e.g., torque sensors, speed sensors, pressure sensors, flowrate sensors, temperature sensors, etc.). For example, in some embodiments, at least one of the sensors 125 is structured as an oil temperature sensor that is used to detect and/or determine an engine oil temperature. The sensors may further include sensors associated with other components of the vehicle (e.g., speed sensor of a turbo charger, fuel quantity and injection rate sensor, fuel rail pressure sensor, etc.).

The sensors 125 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of the speed of the engine 101 (typically expressed in revolutions-per-minute). The sensor is coupled to the engine (when structured as a real sensor) and is structured to send a signal to the controller 140 indicative of the speed of the engine 101. When structured as a virtual sensor, at least one input may be used by the controller 140 in an algorithm, model, lookup table, etc., to determine or estimate a parameter of the engine (e.g., power output, etc.). Any of the sensors 125 described herein may be real or virtual.

The controller 140 is coupled and, particularly communicably coupled, to the sensors 125. Accordingly, the controller 140 is structured to receive data from one more of the sensors 125 and provide instructions/information to the one or more sensors 125. The controller 140 may use the received data to control one more components in the system 100 and/or for monitoring and thermal management purposes.

The operator input/output (I/O) device 130 (shown in FIG. 4) may be coupled to the controller 140, such that information may be exchanged between the controller 140 and the I/O device 130, where the information may relate to one or more components of FIG. 1 or determinations (described below) of the controller 140. The operator I/O device 130 enables an operator of the system 100 to communicate with the controller 140 and one or more components of the system 100 of FIG. 1. For example, the operator I/O device 130 may include, but is not limited to, an interactive display, a touchscreen device, one or more buttons and switches, voice command receivers, etc. In this way, the operator I/O device 130 may provide one or more indications or notifications to an operator, such as a malfunction indicator lamp (MIL), etc. Additionally, the vehicle may include a port that enables the controller 140 to connect or couple to a scan tool so that fault codes and other information regarding the vehicle may be obtained.

In some embodiments, the operator I/O device 130 includes an operator interface device. In some embodiments, the operator interface device is a button or a switch, such as a momentary switch. In other embodiments, the operator interface device is or is part of a graphical user interface provided on a display of the operator I/O device 130. For example, the operator interface device may be an interactable icon or similar element of a graphical user interface that a user can select via a touch input or with another device, such as a keyboard or mouse. In some embodiments, the operator I/O device 130 includes processing circuitry that enables communication between the operator interface device and the controller 140 (e.g., wired and wireless connections).

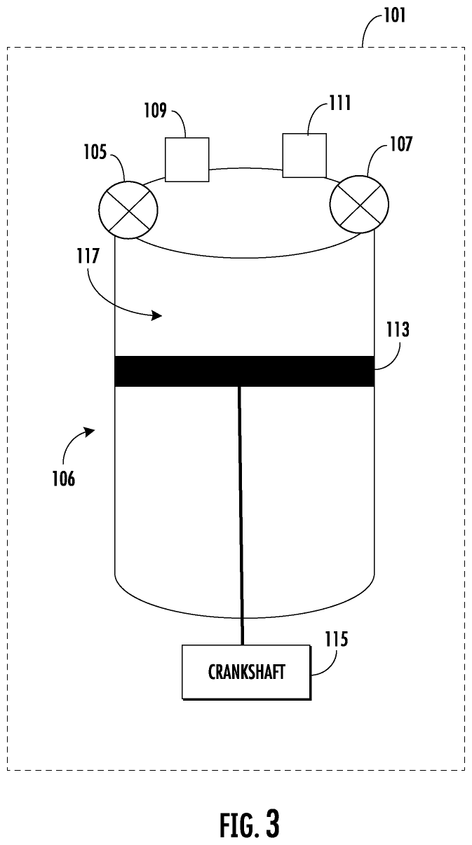

The controller 140 is structured to control, at least partly, the operation of the system 100 and associated sub-systems, such as the engine 101 and the operator I/O device 130. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1. The structure and function of the controller 140 is further described in regard to FIG. 3.

As the components of FIG. 1 are shown to be embodied in a vehicle, the controller 140 may be structured as one or more electronic control units (ECUs), such as one or more microcontrollers. The controller 140 may be separate from or included with at least one of a transmission control unit, an exhaust aftertreatment control unit, a powertrain control module, an engine control module, etc.

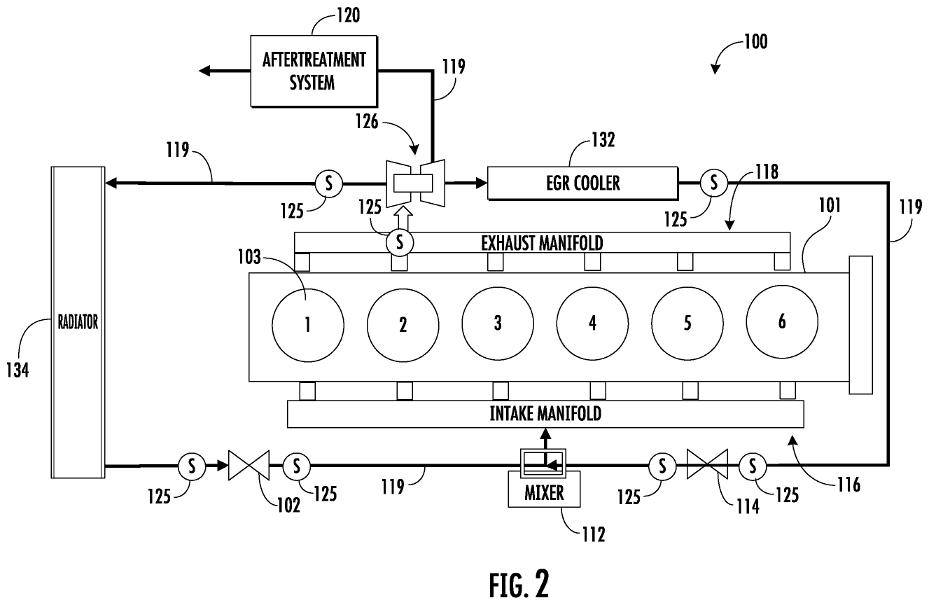

Referring now to FIGS. 2-3, a schematic view of a block diagram of a portion of the system 100 and of a cylinder within the engine 101 are shown, according to example embodiments. The engine 101 includes one or more cylinders 106 (e.g., combustion cylinder). As shown in FIG. 1, the engine 101 includes six cylinders 106. However, it should be understood that the engine 101 may include more or fewer cylinders 106 (e.g., at least one) than as shown in FIG. 1. Furthermore, the cylinders 106 may be provided in varying arrangements, (e.g., in-line, horizontal, V, or other suitable cylinder arrangement).

The engine system 100 includes an exhaust manifold 118. The exhaust manifold 118 is configured to route an exhaust gas stream from the engine 101 to an exhaust conduit 119 (e.g., piping, tubular members, etc.) extending between the exhaust manifold 118 and various components of the system 100. The exhaust conduit 119 is configured to route the exhaust gas stream from the exhaust manifold 118 to a downstream component, such as the aftertreatment system 120 and/or the turbo device 126. In some embodiments, a first portion of the exhaust conduit 119 is disposed between the exhaust manifold 118 and the turbo device 126. The first portion of the exhaust conduit 119 is configured to route the exhaust gas stream from the exhaust manifold 118 to a turbo device 126. In some embodiments, a second portion of the exhaust conduit 119 is disposed between the turbo device 126 and the aftertreatment system 120. The second portion of the exhaust conduit 119 is configured to route the exhaust gas stream from the turbo device 126 to the aftertreatment system 120.

In some embodiments, the system 100 includes an Exhaust Gas Recirculation system (EGR) having an EGR cooler 132 in exhaust gas receiving communication with the turbo device 126, and an EGR valve 114 in exhaust gas receiving communication with the EGR cooler 132. In such an embodiment, a third portion of the exhaust conduit 119 is configured to route the exhaust gas stream from the turbo device 126 to the EGR cooler 132 and a fourth portion of the exhaust conduit 119 is configured to route the exhaust gas stream from the EGR cooler 132 through the EGR valve 114 and to the intake mixer 112. The EGR system is designed to reduce emissions (e.g., NOx emissions, etc.) by recirculating a portion of the exhaust gases back into the intake manifold 116. This lowers combustion temperatures in the cylinders 106 by diluting the air/fuel mixture with inert exhaust gas. Additionally, cooling the exhaust gas via the EGR cooler 132 may reduce engine knock (relative to non-cooled exhaust gas) by lowering combustion temperatures within the cylinders 106.

The EGR valve 114 controls the flow of exhaust gases from the exhaust manifold back into the intake manifold 116. The EGR valve 114 may be actuated (e.g., by an actuator controlled by the controller 140) between a fully open position and a fully closed position. In the fully open position, the EGR valve 114 allows a maximum amount of exhaust gases to flow from the exhaust conduit 119 to the engine 101 and, specifically, to the cylinders 106. This may serve to reduce oxygen concentration within the combustion chambers 117 of the cylinders 106, thereby cooling the combustion process by diluting the air-to-fuel mixture in the cylinders 106 (e.g., relative to a combustion chamber 117 that receives only air from the IAT valve 102, etc.). In the fully closed position, the IAT valve 102 allows a minimum amount of exhaust gas to flow from the exhaust conduit 119 to the engine 101 and, specifically, to the cylinders 106. This may serve to increase oxygen concentration within the combustion chambers 117 of the cylinders 106, thereby heating the combustion process (e.g., relative to a combustion chamber 117 that receives exhaust gas from the EGR valve 114 in an open position, etc.). The controller 140 may selectively actuate the EGR valve 114 (e.g., by controlling the actuator) in a plurality of positions between and/or including the fully open position and the fully closed position to adjust the amount of exhaust gas received by the engine 101.

The EGR cooler 132 is a heat exchanger that reduces the temperature of exhaust gases, relative to an inlet temperature, before they enter the intake manifold 116. In some embodiments, the EGR cooler 132 receives coolant (e.g., refrigerant, water, etc.) from an engine coolant system. The body of the EGR cooler 132 may have a hollow tube or series of tubes that allow the exhaust gas to flow through the EGR cooler 132. Heat is transferred through the walls separating the exhaust gas and the coolant, thereby lowering the temperature of the exhaust gases relative to the inlet temperature of the exhaust gas at the EGR cooler 132.

The engine system 100 includes an intake mixer 112 and an intake manifold 116. Ambient air is drawn into the system 100 by the turbo device 126, and specifically by the compressor 127. The ambient air may pass by a radiator 134 that is structured to cool the engine 101 and the ambient air prior to its entry into the intake mixer 112 and the intake manifold 116. The radiator 134 includes a coolant configured to absorb heat from the engine 101 to cool the engine 101 during the combustion process. As discussed above, the IAT valve 102 is structured to control an amount of air supplied to the engine 101. The intake mixer 112 is configured to route an intake gas stream, including air (e.g., ambient air) from the IAT valve 102, and exhaust gas from the EGR valve 114 to the intake manifold 116. The intake mixer 112 may be a pipe or conduit junction that fluidly couples two or more fluid and/or gas streams together before the gas fluid and/or gas streams are provided to the intake manifold 116. The intake manifold 116 is configured to route the intake gas stream from an intake mixer 112 into the engine 101. More specifically, the intake manifold 116 is configured to route an air-exhaust gas mixture from the intake mixer 112 into each of the cylinders 106.

As shown in FIG. 3, each cylinder 106 has a corresponding igniter 109. The igniter 109 may have a variety of structures, such as a spark plug, a glow plug, etc. The igniter 109 is configured to provide a spark and/or heat to cause an ignition of the charge mixture fuel (e.g., hydrogen, hydrocarbon, etc.) and air within a combustion chamber 117 corresponding to cylinder 106. In example embodiments, igniters 109 ignite fuel according to a spark timing control scheme. The spark timing control scheme may be implemented and adjusted by the controller 140, and more specifically by a spark timing circuit 208 (shown in FIG. 4). Spark timing refers to the moment that igniter 109 ignites the air-fuel mixture (also known as a charge or charge air mixture) inside the combustion chambers 117 of the cylinders 106. Spark timing may be defined in degrees of crankshaft 115 rotation. The controller 140 may operate the igniter 109 to advance spark timing relative to a base spark timing or retard spark timing relative to a base spark timing. Such spark timing is discussed in greater detail with regard to FIGS. 4-6.

In some embodiments, each cylinder 106 has a corresponding fuel injector 111. In these embodiments, the fuel injectors 111 are configured to provide fuel (e.g., hydrogen, hydrocarbon, etc.) to a corresponding cylinder 106. In other embodiments, the fuel injector(s) 111 may be positioned upstream of the cylinders 106 (e.g., at or within an intake manifold, such as the intake manifold 116, described herein). In these embodiments, the fuel injector(s) 111 are configured to provide fuel (e.g., hydrogen, hydrocarbon, etc.) upstream of the cylinders 106 such that the cylinders 106 receive fuel from the fuel injector(s) 111.

In some embodiments, each cylinder 106 includes an intake valve 105 and an exhaust valve 107. The intake valve 105 is selectively positionable between a fully open position and a fully closed position. In the fully closed position, the intake valve 105 prevents or substantially prevents a gas stream from flowing into or out of the cylinder 106. In the open position and positions between the fully open position and the fully closed position, the intake valve 105 allows a gas stream (e.g., an intake gas stream, such as air, air mixed with exhaust, etc.) to enter the cylinder 106. In some embodiments, the intake valve 105 allows the intake gas stream to flow into the cylinder 106 from the intake manifold 116. The exhaust valve 107 is selectively positionable between a fully open position and a fully closed position. In the fully closed position, the exhaust valve 107 prevents or substantially prevents a gas stream from flowing into or out of the cylinder 106. In the fully open position and in positions between the fully open position and the fully closed position, the exhaust valve 107 allows a gas stream (e.g., an exhaust gas stream) to exit the cylinder 106. In some embodiments, the exhaust valve 107 allows the exhaust gas stream to flow into the exhaust manifold 118, described herein.

The intake valve 105 and the exhaust valve 107 are each operable between a fully open position and a fully closed position. When the engine 101 is rotated, the intake valve 105 and the exhaust valve 107 are each operated between the fully open position and the fully closed position. As the intake valve 105 and the exhaust valve 107 are actuated, an intake gas stream (e.g., air or an air-fuel mixture) flows from the intake mixer 112 into the cylinder 106 and an exhaust gas stream (e.g., exhaust gas including air, hydrogen, and/or byproducts from combusting the air-fuel mixture, such as NOx, SOx, water, etc.) flows out of the cylinder 106. In this way, rotation of the engine 101 may facilitate the movement of a gas stream from the intake manifold 116 to the exhaust manifold 118.

Each cylinder 106 includes a piston 113. Each piston 113 is coupled to a crankshaft 115 (e.g., via a connecting rod, a shaft, etc.). The pistons 113 are moveable within the cylinders 106 and, specifically, are configured to move up and down within the cylinders 106 as a result of forces generated during various states of operation of the engine 101. For example, during combustion (e.g., when the igniter 109 ignites fuel within the corresponding cylinder 106) the ignited air-fuel mixture pushes the piston 113 downward within the cylinder 106 (i.e., a “power stroke”). The linear motion of the piston 113 transferred to the crankshaft 115, causing the crankshaft 115 to rotate. As another example, the piston 113 may move downwards within the cylinder 106 to draw in an air-fuel mixture from the intake manifold 116 (i.e., an “intake stroke”). Similarly, the piston 113 may move upward within the cylinder 106 to compress the air-fuel mixture (i.e., a “compression stroke”). As another example, the piston 113 may move upward within the cylinder 106 after and/or during combustion of the air-fuel mixture within the cylinder 106 to expel exhaust gases produced during combustion.

When the engine 101 is operating in low load conditions or idle conditions, the IAT valve 102 is closed or substantially closed. A low load condition typically occurs when a vehicle associated with the engine 101 is cruising at a relatively steady speed, for example, while the vehicle is driving on a highway at a steady speed (e.g., traveling for a predefined number of seconds within a predefined speed range). An idling condition refers to the engine 101 running while the vehicle associated with the engine 101 is stationary, or nearly stationary (e.g., while the vehicle is stopped at a traffic light, while the vehicle is on/running but parked, etc.). The engine 101 requires only a small amount of air for combustion when idling or under low load conditions (e.g., because the engine 101 is producing only the power required to maintain basic operations), thus, the IAT valve 102 restricts airflow to engine 101 in low load or idle conditions.

The IAT valve 102 being in a closed, substantially closed, or minimum open position restricts the amount of air entering the intake manifold 116 while the engine 101 and, specifically, the pistons 113 within the cylinders 106, continue to draw air through downward motion of the pistons 113 within the cylinders 106. This restriction creates a pressure difference, where the air pressure inside the intake manifold 116 becomes lower than atmospheric pressure, resulting in a vacuum. As mentioned above, downward motion of the pistons 113 within the cylinders 106 intakes/pulls air-fuel mixture into the combustion chambers 117 from the intake manifold 116. The pressure difference between the intake manifold 116 (which is under vacuum) and the outside atmosphere causes air to flow toward the intake manifold 116 (e.g., due to the downward motion of the pistons 113), but since the IAT valve 102 is closed or nearly closed, only a limited amount of air can enter the engine 101. As a result, the vacuum within the intake manifold 116 pulls in oil that is present in various parts of the engine 101 (e.g., oil within the pistons 113, oil around the crankshaft 115, etc.) into the combustion chambers 117 of the cylinders 106. This excess oil pulled into the combustion chambers 117 (e.g., the oil pulled into the combustion chamber 117 in addition to the fuel injected into the cylinders 106 by the fuel injector 111) burns alongside the air-fuel mixture when igniter 109 ignites the contents of the combustion chambers 117. Burning the excess oil along with the air-fuel mixture results in exhaust gas having a higher particle number (PN) relative to exhaust gas produced by burning only the air-fuel mixture.

As will be described in greater detail below, the spark timing may be adjusted (e.g., slowed or advanced relative to a base spark timing) by the controller 140 to reduce the vacuum created in the intake manifold 116 when the IAT valve 102 is closed, substantially closed, or in a minimum open position. Specifically, and as will be described in greater detail below, slowing the spark timing increases pressure within the intake manifold 116, thereby reducing the vacuum.

Referring now to FIG. 4, a schematic diagram of the controller 140 of the system 100 of FIG. 1 is shown, according to an example embodiment. As shown, the controller 140 includes at least one processing circuit 202 having at least one processor 204 and at least one memory device 206, a spark timing circuit 208, and a communications interface 210.

In one configuration, the spark timing circuit 208 is embodied as machine- or computer-readable media storing instructions that are executable by a processor, such as processor 204. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or transmission of the data). The computer-readable media instructions may include code, which may be written in any programming language including, but not limited to, Java or the like, and any conventional procedural programming languages, such as the “C” programming language or similar programming languages. The computer-readable program code may be executed on one processor or multiple remote processors. In the latter scenario, the remote processors may be connected to each other through any type of network (e.g., CAN bus, etc.).

In another configuration, the spark timing circuit 208 is embodied as one or more hardware units, such as one or more electronic control units. As such, the spark timing circuit 208 may be embodied as one or more circuitry components including, but not limited to, processing circuitry, network interfaces, peripheral devices, input devices, output devices, sensors, etc. In some embodiments, the spark timing circuit 208 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the spark timing circuit 208 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The spark timing circuit 208 may also include or be programmable hardware devices such as field programmable gate arrays, programmable array logic, programmable logic devices or the like. The spark timing circuit 208 may include one or more memory devices for storing instructions that are executable by the processor(s) of the spark timing circuit 208. The one or more memory devices and processor(s) may have the same definition as provided below with respect to the memory device 206 and processor 204. In some hardware unit configurations, the spark timing circuit 208 may be geographically dispersed throughout separate locations in the vehicle. Alternatively, and as shown, the spark timing circuit 208 may be embodied in or within a single unit/housing, which is shown as the controller 140.

In the example shown, the controller 140 includes the processing circuit 202 having the processor 204 and the memory device 206. The processing circuit 202 may be structured or configured to execute or implement the instructions, commands, and/or control processes described herein with respect to the spark timing circuit 208. The depicted configuration represents the spark timing circuit 208 being embodied as machine-or computer-readable media storing instructions. However, as mentioned above, this illustration is not meant to be limiting as the present disclosure contemplates other embodiments where the spark timing circuit 208 is configured as a hardware unit. All such combinations and variations are intended to fall within the scope of the present disclosure.

The processor 204 may be implemented as one or more single or multi-chip processors, digital signal processors (DSPs), application-specific integrated circuits (ASICs), field-programmable gate arrays (FPGAs), and/or suitable processors (e.g., other programmable logic devices, discrete hardware components, etc.) to perform the functions described herein. A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the spark timing circuit 208 may comprise or otherwise share the same processor, which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 206 (e.g., memory, memory unit, storage device) may include one or more devices (e.g., RAM, ROM, flash memory, hard disk storage) for storing data and/or computer code for completing or facilitating the various processes, layers and modules described in the present disclosure. For example, the memory device 206 may include dynamic random-access memory (DRAM). The memory device 206 may be communicably connected to the processor 204 to provide computer code or instructions to the processor 204 for executing at least some of the processes described herein. Moreover, the memory device 206 may be or include tangible, non-transient volatile memory or non-volatile memory. Accordingly, the memory device 206 may include database components, object code components, script components, or any other type of information structure for supporting the various activities and information structures described herein.

The communications interface 210 may include any combination of wired and/or wireless interfaces (e.g., jacks, antennas, transmitters, receivers, transceivers, wire terminals) for conducting data communications with various systems, devices, or networks structured to enable in-vehicle/system communications (e.g., between and among the components of the vehicle or system when the system is not embodied in a vehicle application) and/or out-of-vehicle communications (e.g., with a remote server). For example, and regarding out-of-vehicle/system communications, the communications interface 210 may include an Ethernet card and port for sending and receiving data via an Ethernet-based communications network and/or a Wi-Fi transceiver for communicating via a wireless communications network. The communications interface 210 may be structured to communicate via local area networks or wide area networks (e.g., the Internet) and may use a variety of communications protocols (e.g., IP, LON, Bluetooth, ZigBee, radio, cellular, near field communication). As shown in FIG. 4, the communications interface 210 may enable communication between the controller 140 and the I/O device 130, the engine 101, the igniter 109, and the sensors 125 (and/or other components and/or systems of FIG. 1).

The spark timing circuit 208 is structured or configured to maintain, or determine an adjustment to, a base spark timing. As mentioned above, spark timing is the timing, relative to a position of the pistons 113 within the cylinders 106 and the angle of the crankshaft 115 of the engine 101, at which the igniter 109 ignites the air-fuel mixture inside the combustion chambers 117 of the cylinders 106. For example, a 0° rotational position of the crankshaft 115 is associated with the position of the crankshaft 115 when the piston 113 is at its highest/top point within the cylinder 106 (e.g., during a compression stroke). The degree position of the crankshaft 115 relative to the 0° position of the crankshaft 115 is used by the spark timing circuit 208 to determine when to activate the igniter 109 to ignite the air-fuel mixture within the combustion chambers 117. For example, a base spark timing may be predefined as a certain number of degrees before the crankshaft 115 reaches the 0° position (e.g., 10-20° before the 0° position). In this way, typically, each time the crankshaft 115 reaches the predefined base spark timing position, the spark timing circuit 208 operates the igniter 109 to ignite the air-fuel mixture within the combustion chambers 117 of the cylinders 106.

The spark timing circuit 208 may adjust the base spark timing to advance or retard the spark timing. As referred to herein, “advancing the spark timing” refers to causing the igniter 109 to ignite the air-fuel mixture within the cylinders 106 before the crankshaft 115 reaches the predefined base spark timing position (e.g., 20-30° before the 0° position) (i.e., the spark timing is advanced relative to the base spark timing). As referred to herein, “retarding the spark timing,” “slowing the spark timing,” and similar terms refer to causing the igniter 109 to ignite the air-fuel mixture within the cylinders 106 after the crankshaft 115 passes the predefined base spark timing position (e.g., at the 0° position, 1-10° after the 0° position).

In example embodiments, the spark timing circuit 208 adjusts the base spark timing based on one or more engine load conditions, such as the controller determining that the engine 101 is in a low load condition or an idle condition. A low load condition typically occurs when a vehicle (when the system is embodied in a vehicle) associated with the engine 101 is cruising at a relatively steady speed, for example, while the vehicle is driving on a highway at a steady speed (e.g., traveling for a predefined number of seconds within a predefined speed range). Another example of a low load condition is when a load sensor acquires information indicative of a load on the engine 101 being at or below a predefined low load threshold. As yet another example of a low load condition, the controller 140 may determine one or more operating conditions associated with a predefined low load condition, such as a hauling weight (e.g., for a vehicle towing a trailer) being at or below a predefined weight threshold (lower weights correspond to lower engine loads), a road grade being at or below a predefined threshold, and/or a combination thereof.

An idling condition refers to the engine 101 running while the vehicle associated with the engine 101 is stationary, or nearly stationary (e.g., while the vehicle is stopped at a traffic light, while the vehicle is on/running but parked, etc.). The idling condition may also correspond to a torque or power output being below a predefined threshold. In which case, the controller 140 determines that the engine 101 is not outputting power for a mission, such as driving the vehicle, hauling weight, etc. The controller may determine an idle condition based on a position of a transmission (not shown) of the system 100. For example, the controller 140 may determine a low load or idle condition when the transmission is in a neutral position or parked position.

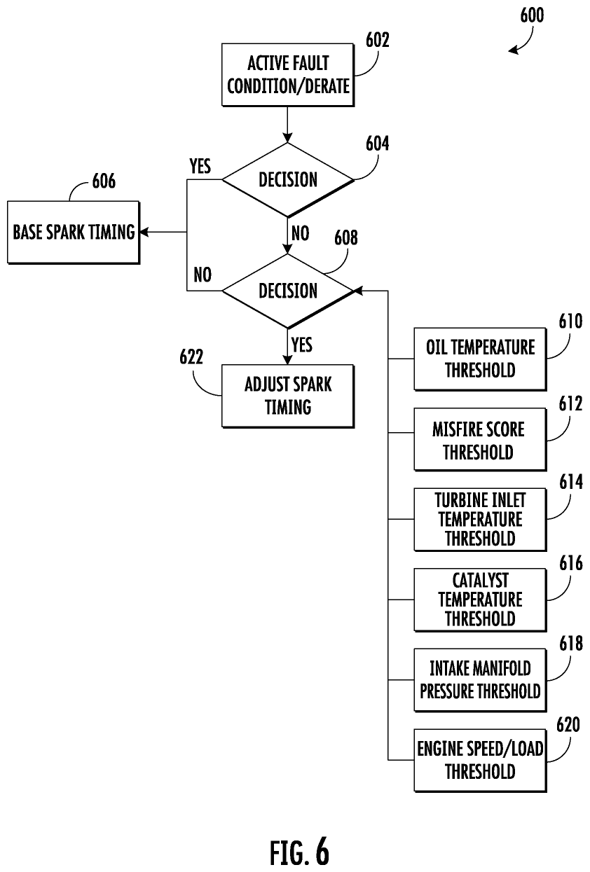

As will be described in greater detail with regard to FIG. 6, the spark timing circuit 208 receives data from one or more of the sensors 125 positioned within the system 100 and compares the data to one or more predefined thresholds. Such data is indicative of the operating condition of the engine 101. For example, a sensor 125 structured as an oil temperature sensor may be used to detect and/or determine an engine oil temperature. The spark timing circuit 208 may compare the data indicative of engine oil temperature to a predefined threshold oil temperature. If the oil temperature is greater than a predefined temperature threshold or falls within a predefined temperature range, the spark timing circuit 208 may determine that the engine 101 is operating under normal/standard load conditions (e.g., while the vehicle associated with the engine 101 is accelerating, while the vehicle operates in stop-and-go traffic, etc.). If the oil temperature falls below the predefined threshold, the spark timing circuit 208 may determine that the engine 101 is operating under low load and/or idle conditions. Lower oil temperatures may correspond with lower load conditions because the engine 101 is generating less heat due to less power output, which corresponds with less heat being removed from the engine 101 and, hence, lower oil temperatures during low load and/or idle conditions. Accordingly, the controller 140 may additionally or alternatively examine an oil temperature to determine a low and/or idle load condition.

As discussed above, in low load and/or idle conditions, the IAT valve 102 may be in a closed, substantially closed, or minimum open position, thereby creating a vacuum within the intake manifold 116. As a result, the vacuum within the intake manifold 116 pulls in oil that is present in various parts of the engine 101 (e.g., oil within the pistons 113, oil around the crankshaft 115, etc.) into the combustion chambers 117 of the cylinders 106. This excess oil pulled into the combustion chambers 117 (e.g., the oil pulled into the combustion chamber 117 in addition to the fuel injected into the cylinders by the fuel injector 111) burns alongside the air-fuel mixture when igniter 109 ignites the contents of the combustion chambers 117. Burning the excess oil along with the air-fuel mixture results in exhaust gas having a higher particle number (PN) relative to exhaust gas produced by burning only the air-fuel mixture. The controller 140, particularly the spark timing circuit 208, is structured to adjust the spark timing relative to the predefined base spark timing to reduce and/or prevent the vacuum within the intake manifold 116.

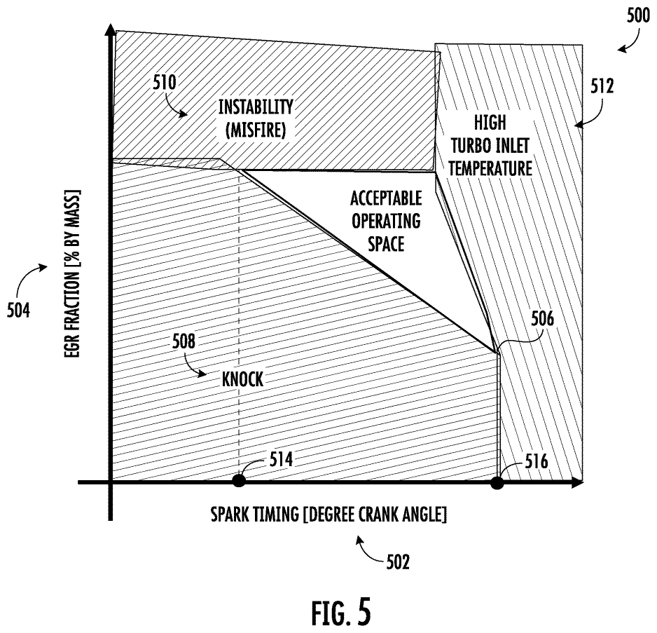

More specifically, and as shown in FIG. 5, the spark timing circuit 208 is structured to adjust the spark timing relative to the predefined base spark timing based on an exhaust gas recirculation (EGR) fraction. FIG. 5 shows a process 500 performed by the controller 140, and more specifically, by the spark timing circuit 208 for adjusting spark timing 502 based on EGR fraction 504. The process 500 is shown to involve graphing the EGR fraction 504, shown as the y-axis, versus spark timing (e.g., the position of the crankshaft 115 relative to the predefined 0° position), shown as the x-axis. The EGR fraction 504 and spark timing 502 are associated with various engine operating conditions. A set of predefined acceptable operating values 506 represents a plurality of operating EGR fractions 504 and spark timings 502 that are associated with normal/standard engine 101 operation. Such a predefined acceptable operating values 506 may be determined by testing data, for example, and may be specific to various engine configurations (e.g., engine architectures, engine-aftertreatment system architectures, architectures of the system as a whole, etc.). Areas outside the graphical space associated with the acceptable operating values 506 represent values associated with engine instability/misfire 510, engine knock 508, and excessive inlet temperature 512 at the turbine 129 of the turbo device 126 relative to a predefined maximum inlet temperature threshold. In this way, the acceptable operating values 506 may include a minimum spark timing threshold 514 and a maximum spark timing threshold 516. The acceptable operating values 506 serve as boundaries for the spark timing circuit 208. For example, the spark timing circuit 208 may advance or slow spark timing relative to the base spark timing within the limits of the predefined acceptable operating values 506 (e.g., to a spark timing between the minimum spark timing threshold 514 and the maximum spark timing threshold 516). By way of example, based on receiving data indicative of the engine 101 idling or operating under low load conditions, the spark timing circuit 208 may calculate the EGR fraction 504, then determine an adjustment and, specifically, a slowing to the base spark timing that falls within the acceptable operating values associated with the calculated EGR fraction 504.

The EGR fraction 504 is a measure or estimation of the proportion of exhaust gases that are recirculated back into the intake air stream of the engine 101 (e.g., the mass flow rate of exhaust gas provided to the intake mixer 112 by the EGR valve 114). The EGR fraction 504 is calculated (e.g., by the controller 140) as the ratio of the mass flow rate of recirculated exhaust gas to the total mass flow rate of the intake mixture (fresh air plus recirculated exhaust gas). For example, to calculate the EGR fraction 504, the controller 140, or more specifically the spark timing circuit 208, may receive a mass flow rate of (a) exhaust gas provided to the intake mixer 112 by the EGR valve 114, and (b) air provided to the intake mixer 112 by the IAT valve 102, from one or more sensors 125. In such an example, the mass flow rate of the exhaust gas provided to the intake mixer 112 is divided by the summation of the mass flow rate of the exhaust gas and the air provided to the intake mixer 112. This yields an EGR fraction 504 indicative of the proportion of exhaust gas present in the total intake gas mixture. The controller 140 may operate the EGR valve 114 and the IAT valve 102 to control the EGR fraction 504 (e.g., such that the EGR fraction 504 aligns with the associated acceptable operating values 506). In this way, the EGR fraction 504 may serve as an independent variable, or an input, which is used to determine a spark timing 502, which serves as a dependent variable or an output value.

As discussed above, spark timing 502 is the timing, relative to a position of the pistons 113 within the cylinders 106 and the angle of the crankshaft 115 of the engine 101, at which the igniter 109 ignites the air-fuel mixture inside the combustion chambers 117 of the cylinders 106. For example, a 0° rotational position of the crankshaft 115 is associated with the position of the crankshaft 115 when the piston 113 is at its highest/top point within the cylinder 106 (e.g., during a compression stroke). The degree position of the crankshaft 115 relative to the 0° position of the crankshaft 115 is used by the spark timing circuit 208 to determine when to activate the igniter 109 to ignite the air-fuel mixture within the combustion chambers 117. For example, a base spark timing may be predefined as a certain number of degrees before the crankshaft 115 reaches the 0° position (e.g., 10-20° before the 0° position). In this way, typically, each time the crankshaft 115 reaches the predefined base spark timing position, the spark timing circuit 208 operates the igniter 109 to ignite the air-fuel mixture within the combustion chambers 117 of the cylinders 106. As shown by the acceptable operating values 506 portion of FIG. 5, multiple spark timing values may align with the acceptable operating values 506. In this way, the predefined base spark timing may be slowed or advanced within the limits of the acceptable operating values 506, while maintaining acceptable operation of the engine 101 (e.g., without causing instability/misfire 510, engine knock 508, or high turbo inlet temperature 512).

As shown in FIG. 5, the spark timing 502 being lower than the minimum spark timing threshold 514, while the EGR aligns with the acceptable operating values 506, may cause engine knock 508. Engine knock 508 occurs when the air-fuel mixture in the combustion chambers 117 ignites prematurely or unevenly. Instead of the igniter 109 initiating the combustion of the air-fuel mixture within the combustion chambers 117, the mixture ignites at multiple points within the cylinders 106 (i.e., detonation). Slowing the spark time 502 such that the spark timing 502 falls below the minimum spark timing threshold 514 may cause engine knock 508 to occur. Specifically, when spark timing 502 is delayed, the pistons 113 may move to or past their highest point within the cylinders 106. This allows the air-fuel mixture more time to compress and build up pressure before ignition (e.g., relative to a base spark timing), which may in turn cause the air-fuel mixture to ignite unexpectedly, creating an engine knock 508.

Similarly, an EGR fraction 504 lower than the acceptable operating values 506 may cause engine knock 508. Exhaust gases contain little oxygen relative to the fresh intake air provided by the compressor 127. By diluting the intake air with exhaust gases, the overall oxygen content in the combustion chambers 117 is reduced (e.g., relative to intake gas comprising purely fresh air, or more fresh air relative to a predefined intake gas standard). If there is not enough exhaust gas re-circulated into the engine 101 or if the EGR fraction 504 is too low, a higher proportion of the intake gas is fresh air from the compressor 127, which can cause the combustion temperature within the combustion chambers 117 to rise. The increase in combustion temperature due to may lead to a greater likelihood of auto-ignition and knock. This is because higher temperatures increase the rate of ignition of the air-fuel mixture, causing multiple ignition points (detonation) rather than a burn initiated by the igniter 109.

The spark timing 502 exceeding the maximum spark timing threshold 516 may cause an inlet temperature to the turbine 129 of the turbo device 126 to exceed a predefined maximum inlet temperature. Advancing the spark timing 502 causes the combustion process within the combustion chambers 117 to start earlier, relative to the base spark timing, while the pressure within the cylinders 106 is relatively high (e.g., relative to the pressure when the pistons 113 are in their highest/top position within the cylinders 106). This causes the peak combustion temperature to increase more than it would with the later base spark timing, thereby producing hotter exhaust gases than would be produced by a combustion at the base spark timing. The hotter exhaust gases are routed to the turbine 129 of the turbo device 126 via the exhaust manifold 118, thereby generating a relatively high turbine 129 inlet temperature. These relatively high inlet temperatures may damage or cause thermal stress on the materials of the turbine 129.

The EGR fraction 504 being higher than the acceptable operating values 506 may cause instability and misfire 510 of the engine 101. Too high of an EGR fraction 504 can cause misfire 510 because it excessively dilutes the air-fuel mixture taken in by the intake manifold 116 with exhaust gases. This dilution reduces the oxygen concentration (e.g., relative to a predefined normal oxygen concentration), making the inlet gas harder to ignite once mixed with fuel, and lowers the combustion temperature, which decreases the energy available to initiate and sustain combustion. This may lead to misfire 510 in which the air-fuel mixture fails to ignite.

Referring now to FIG. 6, a process 600 for adjusting spark timing 502 relative to a base spark timing based on a plurality of operational factors is shown, according to example embodiments. The process 600 may be performed by the controller 140, or more specifically, by the spark timing circuit 208. In some embodiments, a remote computing system (e.g., a cloud system, a provider computing system, etc.) performs all of the process 600 or portions of the process 600. It should be understood that the processes 600 may be performed in a different order, certain of the processes 600 may be omitted, and/or certain processes 600 may be added and still fall within the spirit and scope of the present disclosure.

At process 602, the controller 140 receives data indicative of an engine 101 fault condition or derate (e.g., reduced output of the engine 101 relative to a predefined standard output). For example, to detect fault conditions, the controller 140 may examine whether an onboard diagnostic system has triggered any predefined fault codes. Triggering a fault code may mean that the onboard diagnostic system has detected an operating condition that falls outside normal operating parameters (e.g., exceeds a threshold, falls below a threshold, is outside of a predefined range, etc.) and has logged this information for reference or further action. This is typically indicated by the activation of an indicator lamp, such as a malfunction indicator lamp (MIL) on a vehicle's dashboard. The controller 140 may continuously monitor engine 101 operating data and compare the engine 101 operating data to predefined thresholds. If the observed data deviates from the expected range (e.g., exceeds a threshold, falls below a threshold, is outside of a predefined range, etc.) the controller 140 may generate an alert, regardless of whether a fault code has been triggered by the onboard diagnostic system. In some examples, this alert may be issued in parallel with a fault code, while in other examples, a fault code may not be present.

In some examples, the controller 140 detects, or receives from the onboard diagnostic system, the presence of a fault code specifically associated with a derate condition. The controller 140 may detect engine derate when engine 101 power values (e.g., speed, load, etc.) are actively limited to prevent them from exceeding one or more predefined derate thresholds. For example, engine speed values may be restricted to prevent them from exceeding a predefined derate engine speed limit. In some examples, the controller 140 receives a derate command from a remote server system (e.g., a cloud computing system, a provider computing system, etc.).

At process 604, the controller 140 determines whether an engine 101 fault is present or an engine 101 derate condition is present. If the controller 140 receives data indicative of a fault or derate condition associated with the engine 101, the controller 140 may continue to process 606 and apply the base spark timing to activate the igniters 109.

If the controller 140 determines that a fault condition or derate condition is not present or, in other words, an absence of a fault and/or a derate condition, then the controller continues to process 608. At process 608, the controller 140 receives data indicative of operational factors. In one embodiment, the data indicative of operational factors is specific to PN mitigation, and includes one or more of an oil temperature (e.g., after heat is removed from the engine), a turbine 129 inlet temperature, a catalyst temperature (e.g., the temperature of the aftertreatment system 120 and/or the catalytic devices therein), a pressure within the intake manifold 116, or a speed and/or load on the engine 101. The data indicative of each operational factor may indicate whether or not the engine 101 is operating or likely operating in a low load and/or idle condition.

In some embodiments, the controller may further perform the process 500 to determine a misfire score (also referred to herein as a “misfire value indicator”) based on the EGR fraction 504. As will be described in greater detail below, the controller 140, and more specifically the spark timing circuit 208, is structured to determine whether the engine 101 is operating in low load and/or idling based on a plurality of predefined conditions (610-618), and slow or advance the spark timing 502 accordingly. In some examples, if all the predefined conditions are met, then the controller 140 determines that the engine 101 is operating in low load and/or idle conditions applicable for spark timing adjustment. In other examples, if a single condition or a combination of conditions is met, then the controller 140 determines that the engine 101 is operating in low load and/or idle conditions applicable for spark timing adjustments.

At process 610, the controller 140 receives a temperature indicative of the oil within the engine 101 from one or more sensors 125. More specifically, the controller 140 receives data indicative of oil temperature within the engine 101 from an oil temperature sensor that is used to detect and/or determine an engine oil temperature (i.e., “the oil temperature”). The controller 140 compares the oil temperature to a predefined oil temperature threshold. The predefined oil temperature threshold may be a temperature or a range of oil temperatures associated with or a temperature that, when exceeded, is associated with moderate load and high load engine 101 operations (e.g., engine load conditions other than the low load condition or the idle load condition). For example, the oil temperatures associated with moderate load or high load operations may correspond to oil temperatures during acceleration of a vehicle, during cruising (e.g., maintaining a relatively steady speed on a relatively consistent slope), during climbing conditions (e.g., the vehicle is traveling uphill), and the like. When the engine 101 is operating under low load or idle conditions, the engine 101 generates less heat than it does under moderate load conditions (e.g., due to the engine 101 requiring fewer rotations per minute by the crankshaft 115, thereby slowing the number of combustion cycles per minute). During these conditions, the oil temperature is relatively lower compared to the oil temperature associated with moderate and high load conditions. Accordingly, the oil temperature being at or below the predefined oil temperature threshold indicates to the controller 140 that the engine 101 is operating in a low load or idle condition. In some examples, a remote computing system (e.g., a cloud computing system, a provider computing system, etc.) receives the data indicative of the oil temperature and examines the oil temperature to determine a low and/or idle load condition of the engine 101. In such an example, the controller 140 receives a signal, from the remote computing system, indicating that the engine 101 is in a low and/or idle load condition based on the oil temperature being at or below the predefined threshold oil temperature.

At process 612, the controller 140 determines a misfire value indicator or value of the engine 101. A misfire value indicator is a numerical value that represents the frequency and severity of misfire events occurring within the engine 101. A misfire is a failure of the air-fuel mixture within the combustion chambers 117 of the cylinders 106 to ignite properly during a combustion cycle. The controller 140 calculates the misfire value indicator by monitoring the number of misfires detected per cylinder 106 over a specific period or revolutions-per-minute (RPM) range. The controller 140 may receive data from crankshaft 115 position sensors to detect irregularities in crankshaft 115 acceleration, indicating a loss of combustion in one or more cylinders (i.e., a misfire event). The controller 140 compares the calculated misfire value indicator to a predetermined misfire value indicator threshold range. If the calculated misfire value indicator is within the predetermined misfire value indicator threshold range, then the controller 140 determines that the spark timing 502 may be adjusted (e.g., slowed or advanced) relative to the predefined base spark timing. If the calculated misfire value indicator is outside the misfire value indicator threshold range, the controller 140 may decide not to adjust the spark timing 502 relative to the predefined base spark timing, as such adjustments may cause additional misfire. In some examples, a remote computing system (e.g., a cloud computing system, a provider computing system, etc.) calculates the misfire value indicator and transmits the misfire value indicator to the controller 140. The remote computing system or the controller 140 may compare the misfire value indicator to the predefined misfire value indicator threshold range. For example, the remote computing system may compare the misfire value indicator to the predefined misfire value indicator threshold range. In such an example, the controller 140 may receive a signal, from the remote computing system, indicating that the misfire value indicator threshold range is outside the misfire value indicator threshold range (e.g., below a predefined minimum misfire value indicator threshold range, above a predefined maximum misfire value indicator, etc.).

At process 614, the controller 140 receives an inlet temperature of exhaust gas at the turbine 129 of the turbo device 126. More specifically, the controller 140 receives data indicative of the temperature of exhaust gas flowing into the turbine 129 (i.e., “the turbine 129 inlet temperature”) from an exhaust gas temperature sensor coupled with the exhaust manifold 118 proximate the inlet of the turbine 129, or coupled with the turbine 129 itself (e.g., on or within the housing of the turbine 129). Additionally or alternatively, the controller 140 may receive data indicative of the flow rate of the exhaust entering the turbine 129 (i.e., “the turbine 129 inlet flow rate”) from one or more flow rate sensors positioned proximate to the inlet of the turbine 129 or within the housing of the turbine 129. The controller 140 compares the turbine 129 inlet temperature to a predefined turbine 129 inlet temperature threshold. The predefined turbine 129 inlet temperature threshold may be a range of exhaust gas inlet temperatures associated with, or an exhaust gas temperature that, when exceeded, is associated with moderate load and high load engine 101 operations (e.g., engine load conditions other than the low load condition or the idle load condition). For example, the turbine 129 inlet exhaust temperatures associated with moderate load or high load operations may correspond to exhaust gas temperatures during various conditions, such as acceleration of a vehicle, during cruising, during climbing conditions, and the like. When the engine 101 is operating under low load or idle conditions, the engine 101 generates less heat than it does under moderate load conditions (e.g., due to the engine 101 requiring fewer rotations per minute by the crankshaft 115, thereby slowing the number of combustion cycles per minute). During these conditions, the temperature of the exhaust gas produced by the engine 101 is lower relative to the exhaust gas temperatures associated with moderate load conditions and high load conditions (e.g., because the engine 101 generates less heat). Accordingly, the turbine 129 inlet temperature being at or below the predefined turbine 129 inlet temperature threshold indicates to the controller 140 that the engine 101 is operating in a low load or idle condition in which the IAT valve 102 is closed, nearly closed, or in a minimum open position.

Similarly, the engine 101 produces less exhaust gas in low load and idle conditions relative to moderate and high load conditions (e.g., because the engine 101 consumes less fuel due to the slower number of combustion cycles per minute). The reduced volume of exhaust gas (e.g., relative to the moderate and high load conditions) means that less gas is available within the exhaust manifold 118 to build pressure and push the exhaust gas to the turbo device 126, thereby resulting in a lower flow rate of the exhaust gas at the inlet of the turbo device 126. Accordingly, the turbine 129 inlet temperature being at or below the predefined turbine 129 inlet temperature threshold indicates to the controller 140 that the engine 101 is operating in a low load or idle condition. In some instances, in which the IAT valve 102 is closed, nearly closed, or in a minimum open position. In some examples, a remote computing system (e.g., a cloud computing system, a provider computing system, etc.) receives the data indicative of the turbine 129 inlet temperature and examines the turbine 129 inlet temperature to determine a low and/or idle load condition of the engine 101. In such an example, the controller 140 receives a signal, from the remote computing system, indicating that the engine 101 is in a low and/or idle load condition based on the turbine 129 inlet temperature being at or below the predefined threshold turbine 129 inlet temperature.

At process 616, the controller 140 receives a temperature indicative of one or more catalytic devices within the aftertreatment system 120. The controller 140 receives data indicative of the temperature of one or more catalytic devices (i.e., “the catalyst temperature”) from one or more temperature sensors coupled with and/or inside the aftertreatment system 120 (e.g., on or within the housing of the aftertreatment system 120). The controller 140 compares the catalyst temperature to a predefined catalyst temperature threshold. The predefined catalyst temperature threshold may be a range of catalyst temperatures associated with or a catalyst temperature that, when exceeded, is associated with moderate load and high load engine 101 operations (e.g., engine load conditions other than the low load condition or the idle load condition). For example, the catalyst temperatures associated with moderate load or high load operations may correspond to the temperatures of the catalytic devices during acceleration of a vehicle, during cruising, during climbing conditions, and the like. When the engine 101 is operating under low load or idle conditions, the engine 101 generates less heat than it does under moderate load conditions (e.g., due to the engine 101 requiring fewer rotations per minute by the crankshaft 115, thereby slowing the number of combustion cycles per minute). During these conditions, the temperature of the exhaust gas produced by the engine 101 is lower relative to the exhaust gas temperatures associated with moderate load conditions and high load conditions. Thus, less heat is transferred to the catalytic devices of the aftertreatment system in low load and idle conditions relative to moderate or high load conditions. Accordingly, the catalyst temperature being at or below the predefined catalyst temperature threshold indicates to the controller 140 that the engine 101 is operating in a low load and/or idle condition, and in some of these instances, the IAT valve 102 is closed, nearly closed, or in a minimum open position. In some examples, a remote computing system (e.g., a cloud computing system, a provider computing system, etc.) receives the data indicative of the catalyst temperature and examines the catalyst temperature to determine a low and/or idle load condition of the engine 101. In such an example, the controller 140 receives a signal, from the remote computing system, indicating that the engine 101 is in a low and/or idle load condition based on the catalyst temperature being at or below the predefined catalyst temperature.

At process 618, the controller 140 receives a pressure within the intake manifold 116. More specifically, the controller 140 receives data indicative of the pressure within the intake manifold 116 (i.e., “the intake manifold 116 pressure”) from one or more pressure sensors coupled with the intake manifold 116 (e.g., on or within the intake manifold 116). The controller 140 compares the intake manifold 116 pressure to a predefined intake manifold 116 pressure threshold. The predefined intake manifold 116 pressure threshold may be a range of pressures associated with or a pressure that, when exceeded, is associated with moderate load and high load engine 101 operations (e.g., engine load conditions other than the low load condition or the idle load condition). For example, the intake manifold 116 pressures associated with moderate load or high load operations may correspond to the intake manifold 116 pressures during acceleration of a vehicle, during cruising, during climbing conditions, and the like. As discussed above, in low load and idle conditions, the IAT valve 102 is in a closed, substantially closed, or minimum open position that restricts the amount of air entering the intake manifold 116. In low load and idle conditions, the engine 101, and specifically, the pistons 113 within the cylinders 106, continue to draw air through downward motion of the pistons 113 within the cylinders 106, creating a vacuum within the intake manifold 116 (e.g., a pressure lower than atmospheric pressure). Accordingly, the intake manifold 116 pressure being at or below the predefined intake manifold 116 pressure threshold indicates to the controller 140 that the engine 101 is operating in a low load or idle condition in which the IAT valve 102 is closed, nearly closed, or in a minimum open position. The controller 140 may detect a presence of a vacuum within the intake manifold based on the data indicative of the pressure within the intake manifold 116. For example, the controller 140 may detect a presence of a vacuum within the intake manifold based on the intake manifold 116 pressure being at or below the predefined intake manifold 116. In some examples, a remote computing system (e.g., a cloud computing system, a provider computing system, etc.) receives the data indicative of the intake manifold 116 pressure and examines the intake manifold 116 pressure to determine a low and/or idle load condition of the engine 101. In such an example, the controller 140 receives a signal, from the remote computing system, indicating that the engine 101 is in a low and/or idle load condition based on the intake manifold 116 pressure being at or below the predefined intake manifold 116 pressure.

At process 620, the controller 140 receives an engine 101 speed value (e.g., the rotations per minute of the crankshaft 115) and/or an engine 101 load value (e.g., the amount of torque and/or power the engine 101 produces at a particular time or over a period of operation). More specifically, the controller 140 receives data indicative of the engine 101 speed and/or load (i.e., “the engine 101 speed” and “the engine 101 load”) a crankshaft position sensor, a speed sensor, a throttle position sensor, or the like coupled with the engine 101. In some embodiments, the controller 140 calculates the engine speed and engine load based on the sensor data indicative of the engine 101 speed and/or load. In other embodiments, the controller 140 receives the engine speed and/or the engine load (e.g., from a remote computing system, a fleet manager, a sensor, etc.). The controller 140 compares the engine 101 speed and the engine 101 load to a predefined engine 101 speed threshold and/or load threshold. The predefined engine 101 speed threshold and engine 101 load threshold may be a range of engine 101 speeds and loads associated with, or an engine speed and load that, when exceeded, is associated with moderate load and high load engine 101 operations. For example, the engine 101 speeds and loads associated with moderate load or high load operations may correspond to the engine 101 speeds and loads during acceleration of a vehicle, during cruising, during climbing conditions, and the like. Accordingly, the engine 101 speed and/or the engine 101 load being at or below the predefined to the controller 140 that the engine 101 is operating in a low load or idle condition in which the IAT valve 102 is closed, nearly closed, or in a minimum open position. In some examples, a remote computing system (e.g., a cloud computing system, a provider computing system, etc.) receives the data indicative of the engine speed and/or engine load and examines the engine speed and/or engine load to determine a low and/or idle load condition of the engine 101. In such an example, the controller 140 receives a signal, from the remote computing system, indicating that the engine 101 is in a low and/or idle load condition based on the engine speed and/or engine load being at or below the predefined engine speed and/or engine load thresholds.

As mentioned above, if each, one or more, or a particular combination of the conditions described with respect to process 610 and 614-620 fall below their respective predefined thresholds, and the misfire value indicator of process 612 is within the misfire value indicator threshold range, then the controller 140, and specifically the spark timing circuit 208, proceeds from process 608 to process 622. If each, one or more, or a particular combination of the conditions described with respect to process 610 and 614-620 fall below their respective predefined thresholds, the controller 140 may detect a presence of a vacuum within the intake manifold 116 (e.g., due to the engine 101 being in a low load and/or idle condition). At process 622 the spark timing circuit 208 adjusts the spark timing 502 relative to the base spark timing in order to reduce the vacuum within the intake manifold 116 (e.g., to increase the pressure within the intake manifold 116). Specifically, the spark timing circuit 208 may slow the spark timing 502 relative to the base spark timing. For example, the controller operates the igniter 109 to delay ignition of the air-fuel mixture within the combustion chamber 117 of the cylinder 106 relative to the base spark timing based on determining that the engine load is the low load condition or the idle condition and detecting the presence of the vacuum within the intake manifold 116. By slowing the spark timing 502, ignition of the air-fuel mixture within the combustion chambers 117 is delayed, thereby resulting in less force from the combustion (relative to the base spark timing) pushing the piston 113 downwards within the cylinder 106. As discussed above, the piston 113 moving downwards within the cylinder 106 creates the vacuum within the intake manifold 116. Thus, when the piston 113 has less momentum to pull in air due to the slowed spark timing 502, the vacuum within the manifold is reduced. Advantageously, reducing the vacuum within the intake manifold 116 while the engine 101 is in a low load or idle condition reduces, mitigates, and/or prevents the excess oil within the engine 101 from being pulled into the combustion chambers 117 (e.g., the oil pulled into the combustion chamber 117 in addition to the fuel injected into the cylinders 106 by the fuel injector 111). As noted above, the oil was pulled into the combustion chambers 117 due to the vacuum burns alongside the air-fuel mixture when igniter 109 ignited the contents of the combustion chambers 117. The resulting exhaust gas has a higher particle number (PN) relative to exhaust gas produced by burning only the air-fuel mixture. By reducing the vacuum within the intake manifold 116, the amount of oil pulled into the combustion chambers 117 is also reduced (e.g., relative to the amount of oil pulled into the combustion chambers 117 under the default vacuum). Advantageously, this reduces the particle number of the resulting exhaust gas relative to exhaust gas produced when the engine 101 is under low load or idle conditions with a vacuum in the intake manifold.

If one or more of the conditions described with respect to process 610 and 614-620 are greater than their respective predefined thresholds, or the misfire value indicator of process 612 is outside the misfire value indicator threshold range, then the controller 140, and specifically the spark timing circuit 208, proceeds from process 608 to process 606. At process 606 the spark timing circuit 208 maintains the base spark timing. For example, and as mentioned above, if the misfire value indicator is outside the misfire value indicator threshold range, it may be undesirable to advance or slow spark timing 502, as such an adjustment may cause additional misfire conditions. As another example, in some circumstances, such as when an operator of a vehicle associated with the engine 101 takes their foot off the gas pedal while travelling down a relatively small hill, the engine speed may fall below the engine speed threshold at process 620, while the oil temperature, turbine inlet temperature, and catalyst temperature are each greater than their respective thresholds (e.g., the temperatures exceed a minimum temperature threshold, etc.). In such an example, the controller 140 may determine that the engine 101 is not in a low load or an idle condition despite the speed of the engine 101 being at or below the predefined engine speed threshold because the oil temperature, turbine inlet temperature, and catalyst temperature do not fall below their respective temperature thresholds.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A “coupled” to circuit B may signify that circuit A communicates directly with circuit B (i.e., no intermediary) or communicates indirectly with circuit B (e.g., through one or more intermediaries).

While circuits with particular functionality are shown in FIG. 4, it should be understood that the controller 140 may include any number of circuits for completing the functions described herein. For example, the activities and functionalities of the spark timing circuit 208 may be distributed in multiple circuits or as a single circuit, like shown. Additional circuits with additional functionality may also be included. Further, the controller 140 may further control other activity beyond the scope of the present disclosure.

As mentioned above and in one configuration, the “circuits” may be implemented in machine-readable medium storing instructions for execution by various types of processors, such as the processor 204. An identified circuit of executable code may, for instance, comprise one or more physical or logical blocks of computer instructions, which may, for instance, be organized as an object, procedure, or function. Nevertheless, the executables of an identified circuit need not be physically located together but may comprise disparate instructions stored in different locations, which, when joined logically together, comprise the circuit and achieve the stated purpose for the circuit. Indeed, a circuit of computer-readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations, including over different storage devices, and may exist, at least partially, merely as electronic signals on a system or network.

While the term “processor” is briefly defined above, the terms “processor” and “processing circuit” are meant to be broadly interpreted. In this regard and as mentioned above, the “processor” may be implemented as one or more processors, application-specific integrated circuits (ASICs), field-programmable gate arrays (FPGAs), digital signal processors (DSPs), or other suitable electronic data processing components structured to execute instructions provided by memory. The one or more processors may take the form of a single-core processor, multi-core processor (e.g., a dual-core processor, triple-core processor, quad-core processor, etc.), microprocessor, etc. In some embodiments, the one or more processors may be external to the apparatus, for example, the one or more processors may be a remote processor (e.g., a cloud-based processor). Alternatively or additionally, the one or more processors may be internal and/or local to the apparatus. In this regard, a given circuit, or components thereof, may be disposed locally (e.g., a local computing system, etc.) or remotely (e.g., as part of a remote server such as a cloud-based server). To that end, a “circuit” as described herein may include components that are distributed across one or more locations.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments with various modifications as are suited to the particular use contemplated. Other substitutions, modifications, changes, and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A system for controlling spark timing, comprising:
an igniter configured to ignite an air-fuel mixture within a combustion chamber of an engine cylinder according to a base spark timing; and
a controller coupled with the igniter, the controller comprising one or more processing circuits comprising one or more memory devices coupled to one or more processors, the one or more memory devices configured to store instructions thereon that, when executed by the one or more processors, cause the one or more processors to perform operations comprising:
receiving, from one or more sensors, data indicative of an engine load;
receiving, from the one or more sensors, data indicative of a pressure within an intake manifold coupled with an engine including the engine cylinder;
determining the engine load is a low load condition or an idle condition;
detecting a presence of a vacuum within the intake manifold based on the data indicative of the pressure within the intake manifold; and
operating the igniter to delay ignition of the air-fuel mixture within the combustion chamber relative to the base spark timing based on (a) determining that the engine load is the low load condition or the idle condition and (b) detecting the presence of the vacuum within the intake manifold.

2. The system of claim 1, wherein the one or more memory devices store additional instructions thereon that, when executed by the one or more processors, further cause the one or more processors to perform operations comprising:
receiving, from the one or more sensors, data indicative of an oil temperature of oil within an oil system configured to deliver the oil to the engine;
comparing the oil temperature to a predefined oil temperature threshold; and
determining the engine load is the low load condition or the idle condition based on the oil temperature being at or below the predefined oil temperature threshold.

3. The system of claim 1, wherein the one or more memory devices store instructions thereon that, when executed by the one or more processors, further cause the one or more processors to perform operations comprising:
receiving, from the one or more sensors, data indicative of an inlet temperature of a turbine coupled with the engine;
comparing the inlet temperature of the turbine to a predefined temperature threshold; and
determining the engine load is the low load condition or the idle condition based on the inlet temperature of the turbine being at or below the predefined temperature threshold.

4. The system of claim 1, wherein the one or more memory devices store instructions thereon that, when executed by the one or more processors, further cause the one or more processors to perform operations comprising:
receiving, from the one or more sensors, data indicative of a temperature of one or more catalytic devices coupled with the engine;
comparing the temperature of the one or more catalytic devices to a predefined temperature threshold; and
determining the engine load is the low load condition or the idle condition based on the temperature of the one or more catalytic devices being at or below the predefined temperature threshold.

5. The system of claim 1, wherein the one or more memory devices store instructions thereon that, when executed by the one or more processors, further cause the one or more processors to perform operations comprising:
receiving, from the one or more sensors, data indicative of an engine speed;
comparing the engine speed to a predefined speed threshold; and
determining the engine load is the low load condition or the idle condition based on the engine speed being at or below the predefined speed threshold.

6. The system of claim 1, wherein the one or more memory devices store instructions thereon that, when executed by the one or more processors, further cause the one or more processors to perform operations comprising:
determining an exhaust gas recirculation fraction based on data indicative of a mass flow rate of exhaust gas recirculated into an intake air stream of the engine and a mass flow of air provided to the intake air stream of the engine;
determining a misfire value indicator based on the exhaust gas recirculation fraction; and
operating the igniter to maintain the base spark timing based on determining that the misfire value indicator is outside a threshold range.

7. The system of claim 1, wherein the one or more memory devices store additional instructions thereon that, when executed by the one or more processors, further cause the one or more processors to perform operations comprising:
receiving, from the one or more sensors, data indicative of an oil temperature of oil within an oil system configured to deliver the oil to the engine;
determining the engine load is a load condition other than the low load condition or the idle condition based on the oil temperature being greater than a predefined oil temperature threshold; and
operating the igniter to maintain the base spark timing.

8. The system of claim 1, wherein the one or more memory devices store instructions thereon that, when executed by the one or more processors, further cause the one or more processors to perform operations comprising:
receiving, from the one or more sensors, data indicative of an inlet temperature of a turbine coupled with the engine;
determining the engine load is a load condition other than the low load condition or the idle condition based on the low load condition or the idle condition based on the inlet temperature of the turbine being greater than a predefined temperature threshold; and
operating the igniter to maintain the base spark timing.

9. The system of claim 1, wherein the one or more memory devices store instructions thereon that, when executed by the one or more processors, further cause the one or more processors to perform operations comprising:
receiving, from the one or more sensors, data indicative of a temperature of one or more catalytic devices coupled with the engine;
determining the engine load is a load condition other than the low load condition or the idle condition based on the temperature of the one or more catalytic devices greater than a predefined temperature threshold; and
operating the igniter to maintain the base spark timing.

10. The system of claim 1, wherein the one or more memory devices store instructions thereon that, when executed by the one or more processors, further cause the one or more processors to perform operations comprising:
receiving, from the one or more sensors, data indicative of an engine speed;
determining the engine load is a load condition other than the low load condition or the idle condition based on the engine speed being greater than a predefined speed threshold; and
operating the igniter to maintain the base spark timing.

11. A control system for controlling spark timing, comprising:
one or more processing circuits comprising one or more memory devices coupled to one or more processors, the one or more memory devices configured to store instructions thereon that, when executed by the one or more processors, cause the one or more processors to perform operations comprising:
receiving an indication of an engine load of an engine is a low load condition or an idle condition;
detecting a presence of a vacuum within an intake manifold coupled with to engine based on data indicative of pressure within the intake manifold; and
operating an igniter to delay ignition of an air-fuel mixture within a combustion chamber of the engine relative to a base spark timing based on (a) the engine load being the low load condition or the idle condition and (b) detecting the presence of the vacuum within the intake manifold.

12. The control system of claim 11, wherein the one or more memory devices store additional instructions thereon that, when executed by the one or more processors, further cause the one or more processors to perform operations comprising:
receiving data indicative of an oil temperature of oil within an oil system configured to deliver the oil to the engine;
comparing the oil temperature to a predefined oil temperature threshold; and
determining the engine load is the low load condition or the idle condition based on the oil temperature being at or below the predefined oil temperature threshold.

13. The control system of claim 11, wherein the one or more memory devices store instructions thereon that, when executed by the one or more processors, further cause the one or more processors to perform operations comprising:
receiving data indicative of an inlet temperature of a turbine coupled with the engine;
comparing the inlet temperature of the turbine to a predefined temperature threshold; and
determining the engine load is the low load condition or the idle condition based on the inlet temperature of the turbine being at or below the predefined temperature threshold.

14. The control system of claim 11, wherein the one or more memory devices store instructions thereon that, when executed by the one or more processors, further cause the one or more processors to perform operations comprising:
receiving data indicative of a temperature of one or more catalytic devices coupled with the engine;
comparing the temperature of the one or more catalytic devices to a predefined temperature threshold; and
determining the engine load is the low load condition or the idle condition based on the temperature of the one or more catalytic devices being at or below the predefined temperature threshold.

15. The control system of claim 11, wherein the one or more memory devices store instructions thereon that, when executed by the one or more processors, further cause the one or more processors to perform operations comprising:
receiving data indicative of an engine speed;
comparing the engine speed to a predefined speed threshold; and
determining the engine load is the low load condition or the idle condition based on the engine speed being at or below the predefined speed threshold.

16. The control system of claim 11, wherein the one or more memory devices store instructions thereon that, when executed by the one or more processors, further cause the one or more processors to perform operations comprising:
determining an exhaust gas recirculation fraction based on data indicative of a mass flow rate of exhaust gas recirculated into an intake air stream of the engine and a mass flow of air provided to the intake air stream of the engine;
determining a misfire value indicator based on the exhaust gas recirculation fraction; and
operating the igniter to maintain the base spark timing based on determining that the misfire value indicator is outside a threshold range.

17. The control system of claim 11, wherein the one or more memory devices store additional instructions thereon that, when executed by the one or more processors, further cause the one or more processors to perform operations comprising:
receiving data indicative of an oil temperature of oil within an oil system configured to deliver the oil to the engine;
determining the engine load is a load condition other than the low load condition or the idle condition based on the oil temperature being greater than a predefined oil temperature threshold; and
operating the igniter to maintain the base spark timing.

18. The control system of claim 11, wherein the one or more memory devices store instructions thereon that, when executed by the one or more processors, further cause the one or more processors to perform operations comprising:
receiving data indicative of an inlet temperature of a turbine coupled with the engine;
determining the engine load is a load condition other than the low load condition or the idle condition based on the low load condition or the idle condition based on the inlet temperature of the turbine being greater than a predefined temperature threshold; and
operating the igniter to maintain the base spark timing.

19. The control system of claim 11, wherein the one or more memory devices store instructions thereon that, when executed by the one or more processors, further cause the one or more processors to perform operations comprising:
receiving data indicative of a temperature of one or more catalytic devices coupled with the engine;
determining the engine load is a load condition other than the low load condition or the idle condition based on the temperature of the one or more catalytic devices greater than a predefined temperature threshold; and
operating the igniter to maintain the base spark timing.

20. A method of controlling spark timing, comprising:
receiving, from one or more sensors, data indicative of an engine load of an engine;
receiving, from the one or more sensors, data indicative of a pressure within an intake manifold coupled with the engine;
determining the engine load is a low load condition or an idle condition;
detecting a presence of a vacuum within the intake manifold based on the data indicative of the pressure within the intake manifold; and
operating an igniter to delay ignition of an air-fuel mixture within a combustion chamber of the engine relative to a base spark timing based on (a) determining that the engine load is the low load condition or the idle condition and (b) detecting the presence of the vacuum within the intake manifold.
